(19) United States
(12) Patent Application Publication
(10) Pub. No.: US 2026/0188062 A1
(43) Pub. Date: Jul. 2, 2026

(54) Failure Diagnosis System, Failure Diagnosis Device, and Failure Diagnosis Method

(71) Applicant: Hitachi, Ltd., Chiyoda-ku, Tokyo (JP)

(72) Inventors: Tadanobu TOBA, Tokyo (JP); Shuichi NISHINO, Tokyo (JP); Yutaka UEMATSU, Tokyo (JP); Takumi UEZONO, Tokyo (JP); Kenichi SHIMBO, Tokyo (JP)

(21) Appl. No.: 18/864,586

(22) PCT Filed: Apr. 7, 2023
(86) PCT No.: PCT/JP2023/014324

§ 371 Date: Nov. 11, 2024

(30) Foreign Application Priority Data
Jun. 28, 2022 (JP) 2022-103964

(51) Int. Cl. G06F 11/07; G06F 11/30

(52) U.S. Cl. CPC G06F 11/079; G06F 11/3068

(57) ABSTRACT

By converting various types of data into data in a more easily usable format, failure diagnosis can be performed more efficiently using the data.

A failure diagnosis system includes: an edge system which is an electronic system; a failure diagnosis device configured to diagnose a failure of the edge system; and a computer which is an external device. The failure diagnosis device distinguishes data acquired from the edge system and the computer according to a type of the data, extracts a data element included in the data based on predetermined interpretation processing for the data, converts the data element into a predetermined data code corresponding to an item of a common data format regardless of the type of the data, and generates diagnosis intermediate data in which the data code is assigned to the corresponding item, and performs diagnosis analysis of a failure in the edge system using the diagnosis intermediate data.

### TECHNICAL FIELD

The present invention relates to a failure diagnosis system, a failure diagnosis device, and a failure diagnosis method. The invention claims the priority of Japanese Patent Application No. 2022-103964 filed on Jun. 28, 2022, and the contents described in the application are incorporated into the present application by reference in the designated country where incorporation by reference of literatures is permitted.

### BACKGROUND ART

In recent years, an electronic system (sometimes referred to as an edge system) for self-driving vehicles, robots and the like has been used in various places and scenes. It is known that the occurrence of a failure in the edge system is not only caused by a breakdown of the system itself but also affected by a situation or an environmental condition in a use scene. However, since it is difficult to reproduce the situation or the environmental condition of the use scene, it is very difficult to specify a specific cause of failure.

For this reason, in order to specify the cause of failure occurring in the edge system, it is considered necessary to collect various types and various formats of data such as a system internal state, abnormality detection, diagnosis information, data output from a sensor, environmental information, and user information, and comprehensively analyze the data.

On the other hand, when using various types of data, the various types of data has different data formats and data expression for each data provider such as a manufacturer that is a data source. Therefore, there is a problem that it is difficult to efficiently perform statistical processing, machine learning, and the like for specifying the cause of failure by using the collected data as it is.

PTL 1 discloses a technique relating to a system that collects operation data of a machine and creates an analysis flow thereof. Specifically, PTL 1 discloses that “an analysis flow of a past case in which an abnormality of a machine is detected by analyzing operation data of the machine and intermediate information having a space for inputting setting parameters and know-how information of each analysis procedure of an analysis flow currently being created are accumulated. When creating a new analysis flow, a user retrieves know-how information from intermediate information of accumulated past cases, and creates an analysis flow with reference to a retrieval result.”

### CITATION LIST

### Patent Literature

PTL 1: JP 2020-8918A

### SUMMARY OF INVENTION

### Technical Problem

In the technique disclosed in PTL 1, data from various sensors is collected and analyzed when monitoring the state of plant equipment or the like. In the technique disclosed in the literature, the analysis procedure and the know-how are converted into a common data format (intermediate format) and stored in a database. However, in the technique disclosed in the literature, a data analysis procedure is manually input, and the procedure is converted into a common format to enhance versatility. For this reason, in the technique disclosed in the literature, no consideration is given to unifying different formats of data into a common format and performing failure diagnosis of an electronic system using data in the unified format.

The invention has been made in view of the above problem, and an object thereof is to convert various types of data into data in a more easily usable format, thereby performing more efficient failure diagnosis using the data.

### Solution to Problem

The present application includes a plurality of means for solving at least a part of the above problems, and examples thereof are as follows. In order to solve the above problems, a failure diagnosis system according to an aspect of the invention includes: an edge system which is an electronic system; a failure diagnosis device configured to diagnose a failure of the edge system; and a computer which is an external device. The failure diagnosis device distinguishes data acquired from the edge system and the computer according to a type of the data, extracts a data element included in the data based on predetermined interpretation processing for the data, converts the data element into a predetermined data code corresponding to an item of a common data format regardless of the type of the data, and generates diagnosis intermediate data in which the data code is assigned to the corresponding item, and performs diagnosis analysis of a failure in the edge system using the diagnosis intermediate data.

### Advantageous Effects of Invention

According to the invention, by converting various types of data into data in a more easily usable format, it is possible to more efficiently perform failure diagnosis using the data.

Problems, configurations, effects, and the like other than those described above will be clarified in the description of the following embodiments.

### BRIEF DESCRIPTION OF DRAWINGS

FIG. 1 is a diagram illustrating an example of a schematic configuration of a failure diagnosis system according to a first embodiment.

FIG. 2 is a diagram illustrating an example of a format (data format) of diagnosis intermediate data.

FIG. 3 is a diagram illustrating an example of definitions corresponding to codes of items of a format.

FIG. 4 is a diagram illustrating definitions relating to data details and code conversion of data classification in a case where a data type (TYP) is VID (vehicle internal data).

FIG. 5 is a diagram illustrating definitions relating to data details and code conversion of data classification in a case where a data type (TYP) is VPD (probe data).

FIG. 6 is a diagram illustrating definitions relating to data details and code conversion of data classification in a case where a data type (TYP) is EVD (environmental data).

FIG. 7 is a diagram schematically illustrating rearranged (sorted) and merged diagnosis intermediate data.

FIG. 8 is a diagram illustrating an example of failure diagnosis processing.

FIG. 9 is a diagram illustrating an example of a schematic configuration of a failure diagnosis system according to a second embodiment.

FIG. 10 is a diagram illustrating an example of an influence degree.

FIG. 11 is a diagram illustrating an example of a hardware configuration of a failure diagnosis device.

### DESCRIPTION OF EMBODIMENTS

Hereinafter, embodiments according to the invention will be described with reference to the drawings. The embodiments are examples for describing the invention, and are omitted and simplified as appropriate for clarity of description. The invention can be implemented in various other forms. Unless otherwise specified, each component may be single or plural.

In order to facilitate understanding of the invention, the position, size, shape, range, and the like of each component shown in the drawings may not represent the actual position, size, shape, range, and the like. Therefore, the invention is not necessarily limited to the positions, sizes, shapes, ranges, and the like disclosed in the drawings.

As examples of various types of information, expressions such as “table” may be used for description, and the various types of information may be expressed in other data structures. For example, various types of information such as “XX table” may be “XX information”. In describing £ identification information, when expressions such as “identification information”, “identifier”, “name”, “ID”, and “number” are used, the expressions can be replaced with one another.

When there are a plurality of components having the same or similar functions, the description may be made by assigning different subscripts to the same reference sign. When it is not necessary to distinguish the plurality of components, the description may be made by omitting the subscripts.

In the embodiments, processing performed by executing a program may be described. Here, a computer executes the program by a processor (for example, a CPU or a GPU) and performs processing defined by the program using a storage resource (for example, a memory), an interface device (for example, a communication port), and the like. Therefore, a subject of the processing performed by executing the program may be the processor. Similarly, the subject of the processing performed by executing the program may be a controller, a device, a system, a computer, or a node including a processor. The subject of the processing executed by executing the program may be a calculation unit and may include a dedicated circuit that executes specific processing. Here, the dedicated circuit is, for example, a field programmable gate array (FPGA), an application specific integrated circuit (ASIC), and a complex programmable logic device (CPLD).

The program may be installed in the computer from a program source. The program source may be, for example, a program distribution server or a computer-readable storage medium. When the program source is the program distribution server, the program distribution server may include a processor and a storage resource for storing a program to be distributed, and the processor of the program distribution server may distribute the program to be distributed to another computer. In an example, two or more programs may be implemented as one program, or one program may be implemented as two or more programs.

### First Embodiment

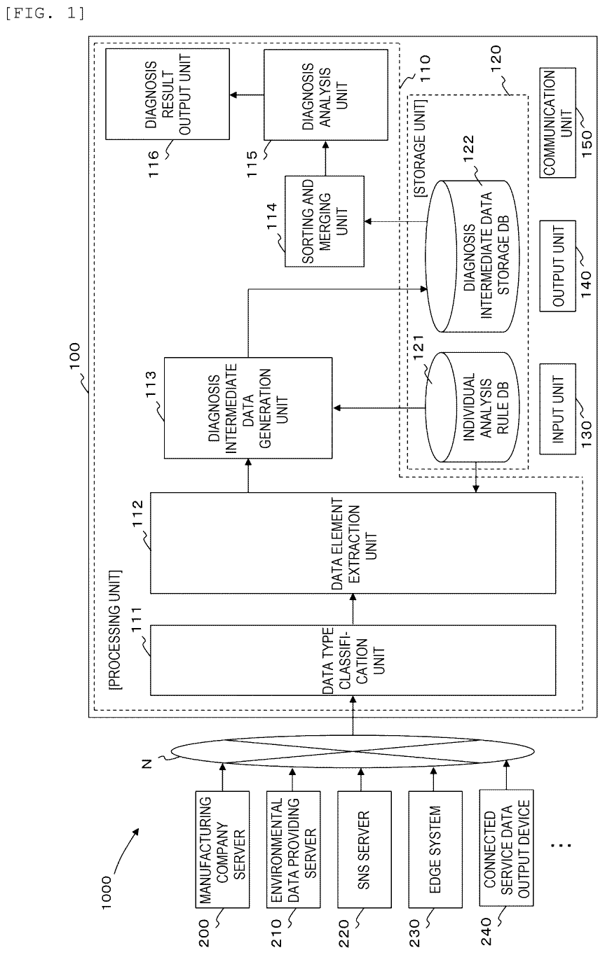

FIG. 1 is a diagram illustrating an example of a schematic configuration of a failure diagnosis system 1000 according to the embodiment. As illustrated, the failure diagnosis system 1000 includes a failure diagnosis device 100, a manufacturing company server 200, an environmental data providing server 210, a social networking service (SNS) server 220, an edge system 230, and a connected service data output device 240 (hereinafter, these devices may be referred to individually or collectively as an “external device”). These devices are communicably connected to one another via a predetermined network N such as a public network like the Internet or a local area network (LAN) or a wide area network (WAN).

The following description will be made using an example of a case where the edge system 230 of the embodiment is a system that is mounted on a moving body (for example, an automobile) and electronically controls driving of the moving body.

The failure diagnosis device 100 is a computer that converts data of various types and formats acquired from an external device into data in a unified data format and diagnoses a failure or a breakdown in the edge system 230 using the converted data. Specifically, the failure diagnosis device 100 acquires (collects) various types of data from the manufacturing company server 200, the environmental data providing server 210, the SNS server 220, the edge system 230, and the connected service data output device 240. The failure diagnosis device 100 converts the various types of data into data in a unified data format in accordance with a predetermined format, thereby converting data of different types or formats into data in the same format and generating diagnosis intermediate data in the unified data format.

The failure diagnosis device 100 rearranges the pieces of data in time series based on time elements included in the diagnosis intermediate data and merges the pieces of data, thereby generating a data set that is easily used for diagnosis analysis of failure, machine learning of an information model used for diagnosis, and the like.

The failure diagnosis device 100 performs diagnosis analysis for specifying a cause of failure in the edge system 230 by using the rearranged or merged diagnosis intermediate data.

The manufacturing company server 200 is a computer used by a manufacturing company or dealer of an automobile equipped with the edge system 230, and provides various types of data to the failure diagnosis device 100. For example, the manufacturing company server 200 provides, to the failure diagnosis device 100, user data including product data including a product model number and a product configuration (for example, a component of an ECU) and interview data from a customer related to a failure.

The environmental data providing server 210 is a computer used by a company that provides environmental data related to weather such as temperature, and provides various types of data to the failure diagnosis device 100. For example, the environmental data providing server 210 provides, to the failure diagnosis device 100, environmental data including weather conditions such as weather, temperature, and humidity, and road surface conditions such as freezing and unevenness.

The SNS server 220 is a computer used by a company that provides a social networking service, and provides various types of data to the failure diagnosis device 100. For example, the SNS server 220 provides, to the failure diagnosis device 100, user comment data including a user comment, a dealer comment, or the like related to a moving body (automobile) on which the edge system 230 is mounted.

The edge system 230 is a system that provides internal data and the like of a moving body to the failure diagnosis device 100. Specifically, the edge system 230 provides vehicle internal data and probe data to the failure diagnosis device 100. More specifically, the edge system 230 provides, to the failure diagnosis device 100, vehicle internal data including breakdown diagnosis data and register information and probe data including temperature, vibration, travel history, and the like.

The connected service data output device 240 is a computer that provides various types of connected services, and provides connected service data to the failure diagnosis device 100. Specifically, the device is, for example, a computer that performs data management and communication with an infrastructure facility or the like called a management device that manages a smartphone and a charging station of an electric vehicle.

For example, when an automobile and a smartphone are linked to each other in order to open or close a door of the automobile, the connected service data output device 240 receives a request from the smartphone, and generates and transmits a door opening and closing control instruction to the target automobile. Failure information (for example, a communication log) in a communication path from the smartphone to the automobile is acquired by the connected service data output device 240. The connected service data output device 240 provides the acquired failure information to the failure diagnosis device 100. When the connected service data output device 240 is a management device of a charging station, the device 240 provides log data collected via the charging station to the failure diagnosis device 100.

Each of the external devices may be provided in single or multiple units, or only a specific type of the external device may be provided in multiple units. The failure diagnosis system 1000 does not necessarily include all these external devices, and may include, for example, the edge system 230, the failure diagnosis device 100, and the environmental data providing server 210. That is, the edge system 230 and the failure diagnosis device 100 are essential components in the failure diagnosis system 1000, and combinations of other external devices included in the system are not particularly limited.

The schematic configuration of the failure diagnosis System 1000 is described above.

The device as a data providing source for providing various types of data to the failure diagnosis device 100 is not limited to the above example, and any device (computer) may be included as long as the device is a providing source device of data that is considered to be useful for failure diagnosis of the target edge system 230.

Next, an example of a schematic configuration of the failure diagnosis device 100 will be described.

As illustrated in FIG. 1, the failure diagnosis device 100 includes a processing unit 110, a storage unit 120, an input unit 130, an output unit 140, and a communication unit 150.

The processing unit 110 is a functional unit configured to perform various types of processing to be executed by the failure diagnosis device 100. Specifically, the processing unit 110 includes a data type classification unit 111, a data element extraction unit 112, a diagnosis intermediate data generation unit 113, a sorting and merging unit 114, a diagnosis analysis unit 115, and a diagnosis result output unit 116.

The data type classification unit 111 is a functional unit configured to classify various types of data acquired from an external device. Specifically, the data type classification unit 111 distinguishes between data types based on a transmission source address of the acquired data or an ID assigned to the data (for example, an identification ID of a transmitter assigned to the data in general communication, an identification ID of the external device, or an ID indicating the data type).

More specifically, based on the ID, the data type classification unit 111 determines whether the data is user data acquired from the manufacturing company server 200, environmental data acquired from the environmental data providing server 210, user comment data acquired from the SNS server 220, vehicle internal data or probe data acquired from the edge system 230, or data acquired from the connected service data output device 240.

The data type classification unit 111 outputs the distinguished data to the data element extraction unit 112 together with information specifying the type thereof.

The data element extraction unit 112 is a functional unit configured to extract a data element from the distinguished data. Specifically, based on rule information stored in an individual analysis rule DB 121, the data element extraction unit 112 specifies a data structure and a lexical and term rule corresponding to data formats varying depending on the data type and the data providing source. The data element extraction unit 112 performs data interpretation processing (for example, syntax analysis processing and natural language analysis) according to the rule information. Accordingly, the data element extraction unit 112 extracts a predetermined data element (for example, data details, data classification, a data acquisition time or an event occurrence time, an event duration time or a cycle thereof, an event occurrence portion, and state data) for each data type corresponding to the data providing source from the data acquired from the external device.

A parser generator such as the yet another compiler-compiler (YACC) may be used for interpretation processing such as syntax analysis and natural language analysis.

The diagnosis intermediate data generation unit 113 is a functional unit configured to convert data of different types and formats into data of the same format and generates diagnosis intermediate data in a unified data format. Specifically, the diagnosis intermediate data generation unit 113 converts the data type and the extracted data element into a data code (hereinafter, may be referred to as a “code”) according to a predetermined format rule. The diagnosis intermediate data generation unit 113 assigns the converted code to a corresponding data field (hereinafter, may be referred to as an “item”) of the format. The diagnosis intermediate data generation unit 113 assigns actual values of the event occurrence time and the data to corresponding items without encoding the values.

As described above, the diagnosis intermediate data generation unit 113 converts the extracted data element into a predetermined data code corresponding to an item of a common data format regardless of the data type, and generates diagnosis intermediate data in which the code is assigned to the corresponding item.

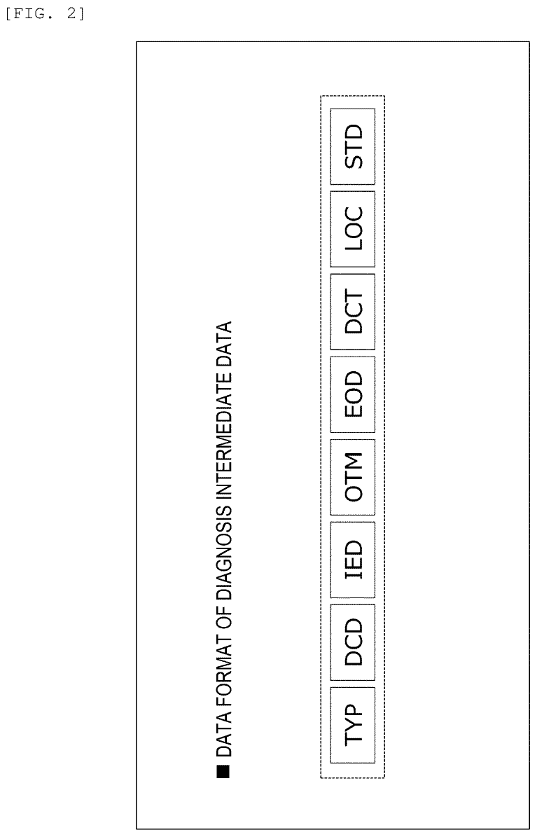

FIG. 2 is a diagram illustrating an example of a format (data format) of diagnosis intermediate data. As shown in the drawing, the format of the diagnosis intermediate data has predetermined items to which a code obtained by converting a data element and an actual value of data are assigned. Specifically, the format includes a plurality of items such as TYP, DCD, IED, OTM, EOD, DCT, LOC, and STD. An individual identification code (for example, in the case of an automobile, a vehicle identification number (VIN) ) of the edge system 230 may be separately added to the data collected from the edge system 230. The identification code can be used to identify the automobile from which the data is acquired. Therefore, the identification code is not an essential element of the diagnosis intermediate data, and may be added to the diagnosis intermediate data as necessary.

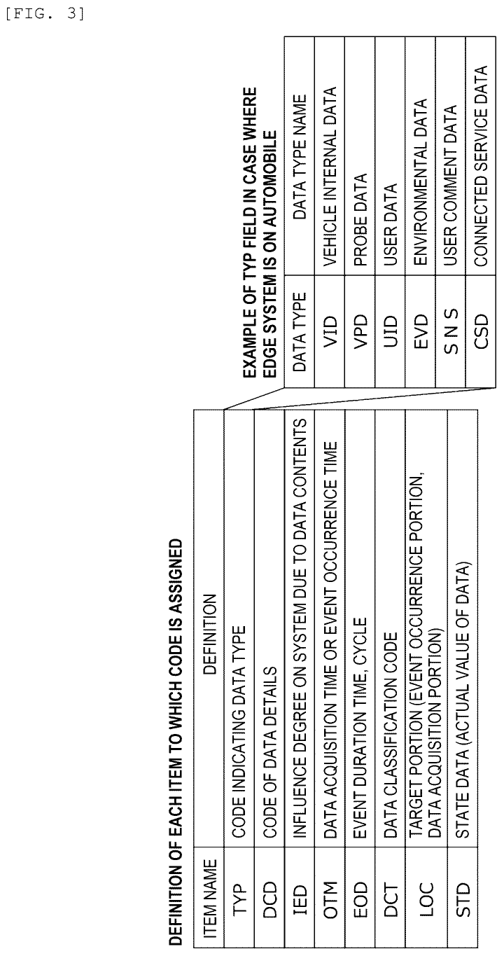

FIG. 3 is a diagram illustrating an example of definitions corresponding to codes of the items of the format. As shown in the drawing, the TYP is defined as an item to which a code indicating a data type is assigned.

The DCD is defined as an item to which a code indicating data details is assigned. Data details will be described later.

The IED is defined as an item to which a value indicating an influence degree on the system due to data contents is assigned. The influence degree will be described in detail in a second embodiment described later.

The OTM is defined as an item to which a data acquisition time or an event occurrence time is assigned.

The EOD is defined as an item to which a code obtained by converting an event duration time or an event occurrence cycle is assigned.

The DCT is defined as an item to which a data classification code is assigned. Details of the data classification will be described later. The DCT is used as an element for interpreting contents of the STD to which an actual value of state data is assigned.

The LOC is defined as an item to which a code indicating a target portion (for example, an event occurrence portion such as a processor or a memory or a data acquisition portion) where a failure occurs is assigned.

The STD is defined as an item to which an actual value of data which is state data is assigned.

In the embodiment in which a case where the edge system 230 is mounted on an automobile is described, codes indicating data types such as VID, VPD, UID, EVD, SNS, and CSD are assigned to the TYP. Here, the VID is a code indicating vehicle internal data. The VPD is a code indicating probe data. The UID is a code indicating user data. The EVD is a code indicating environmental data. The SNS is a code indicating user comment data. The CSD is a code that indicates connected service data.

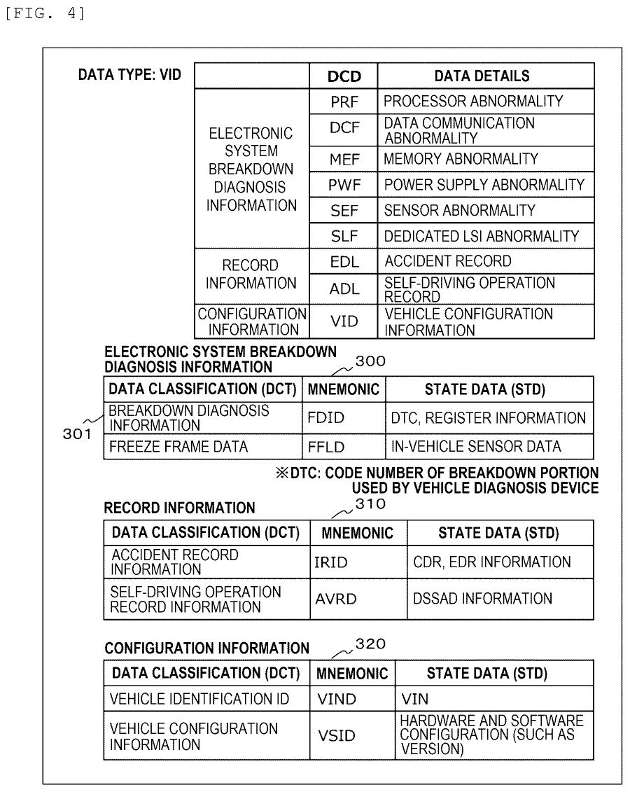

FIG. 4 is a diagram illustrating definitions relating to data details and code conversion of data classification in a case where the data type (TYP) is the VID (vehicle internal data). The diagnosis intermediate data generation unit 113 encodes contents of extracted data elements according to the definitions and assigns the codes to corresponding items of the data format.

For example, when information included in an extracted data element and indicating data details indicates a power supply abnormality, the diagnosis intermediate data generation unit 113 converts the information into a code called PWF and assigns the code to the item of DCD of the format.

A power supply abnormality included in electronic system breakdown diagnosis information corresponds to register information acquired from a register. Therefore, the diagnosis intermediate data generation unit 113 specifies a record 301 in an electronic system breakdown diagnosis information table 300 in which the register information is associated with the state data. Further, the diagnosis intermediate data generation unit 113 converts breakdown diagnosis information corresponding to data classification of the specified record into a code=FDID defined by a mnemonic of the record, and assigns the code to the DCT item of the format.

The diagnosis intermediate data generation unit 113 specifies state data which is register information from the extracted data elements, and assigns an actual value of the state data to the STD of the format. The state data may be, for example, a trouble code indicated by the corresponding DCT (breakdown diagnosis information in this example), or may be converted into a data code indicating a state or a functional failure indicated by the trouble code and then assigned to the STD.

For example, when the mnemonic of the DCT corresponding to the extracted data element is FELD, the diagnosis intermediate data generation unit 113 assigns data extracted from output data from a sensor mounted in the vehicle or a storage destination address link of the extracted data to the STD of the format. Accordingly, it is possible to read data and change the processing procedure in the diagnosis analysis processing, for example.

In this manner, the diagnosis intermediate data generation unit 113 assigns the codes or actual values of the extracted data elements to the corresponding items (DCD, DCT, and STD) of the format.

When the DCT specified by an extracted data element is IRID in a record information table 310, it is indicated that the data element is data regarding a unit (CDR or EDR) that acquires a log at the time of occurrence of an accident. In diagnosis analysis using the diagnosis intermediate data, it is determined based on such information that analysis processing in the case of an accident different from that in normal operation is necessary.

When the DCT specified by the extracted data element is AVRD in the record information table 310, it is indicated that the data element is state information (DSSA information) at the time of self-driving. The diagnosis intermediate data in which the AVRD is assigned to the DCT can be used in both diagnosis analysis processing at the time of normal operation and diagnosis analysis processing at the time of an accident.

When the DCT specified by the extracted data element is VIND or VSID in a configuration information table 320, it is indicated that the data element is data regarding an identification ID code unique to the vehicle or configuration information. The diagnosis intermediate data in which such DCT is assigned is used as an identifier (ID) when performing diagnosis analysis processing unique to a target vehicle.

As described above, the data code assigned to the item of the diagnosis intermediate data serves as control information used for determining processing contents and a processing order and controlling the processing when the diagnosis analysis unit 115 described later performs failure diagnosis analysis.

Returning to FIG. 2, description will be made. The diagnosis intermediate data generation unit 113 specifies, from a data element, an acquisition time of data from an external device or an event occurrence time, and assigns the specified time to the OTM of the format.

For example, the diagnosis intermediate data generation unit 113 specifies, from the data element, an event duration time and an event occurrence cycle for an abnormality or the like, and assigns the event duration time and the event occurrence cycle to the EOD of the format. The event duration time is not encoded, and an actual value thereof is assigned to the EOD. With respect to the cycle, a code obtained by converting a predetermined category (time attribute) according to the length of the cycle is assigned to the EOD. Specifically, a short cycle (seconds to minutes) is defined as category 1, a medium cycle (minutes to hours) as category 2, a long cycle (hours or longer) as category 3, and discretion (point process data) as category 4, and codes obtained by converting these categories are assigned to the EOD.

The cycle encoded in this manner is used for interpolation of the cycle between various types of data, for example, when executing a time series analysis algorithm in the diagnosis analysis processing performed by the diagnosis analysis unit 115.

The diagnosis intermediate data generation unit 113 specifies, from the data element, a target portion (for example, an event occurrence portion such as a processor or a memory or a data acquisition portion) where a failure occurs. The diagnosis intermediate data generation unit 113 converts the specified target portion into a corresponding code and assigns the code to the LOC of the format.

As described above, the data codes indicating the states of the automobile, which is a moving body, are assigned to the diagnosis intermediate data generated based on the data elements of the vehicle internal data.

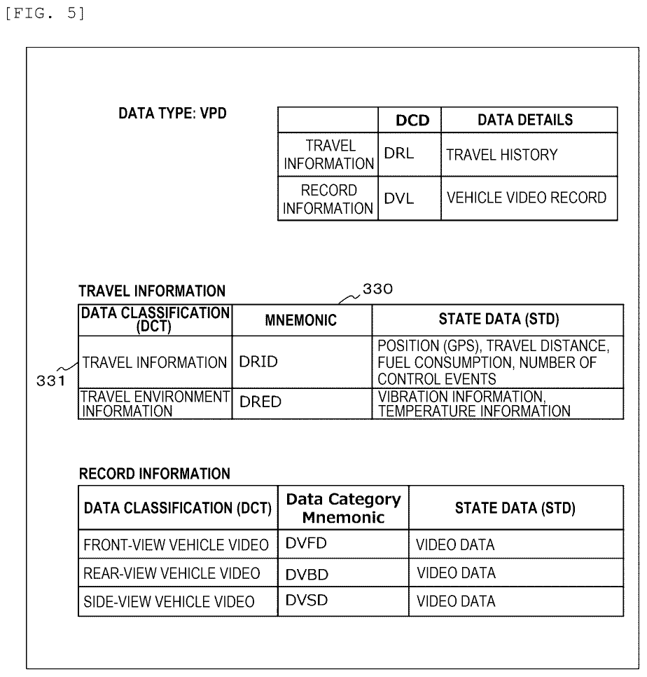

FIG. 5 is a diagram illustrating definitions relating to data details and code conversion of data classification in a case where the data type (TYP) is the VPD (probe data). The diagnosis intermediate data generation unit 113 encodes contents of extracted data elements according to the definitions and assigns the codes to corresponding items of the data format.

For example, when information included in an extracted data element and indicating data details indicates a travel history, the diagnosis intermediate data generation unit 113 converts the information into a code called DRL and assigns the code to the item of DCD of the format.

In this case, the diagnosis intermediate data generation unit 113 specifies a record 331 in a travel information table 330 in which the travel history is associated with state data. Further, the diagnosis intermediate data generation unit 113 converts travel information corresponding to data classification of the specified record into a code=DRID defined by a mnemonic of the record, and assigns the code to the DCT item of the format.

The diagnosis intermediate data generation unit 113 specifies the state data of the travel history from the extracted data element, and assigns an actual value of the state data to the STD of the format.

Since the probe data is data acquired in a cyclic manner, actual values of acquired data are stored in the STD. A storage destination address link of continuous data obtained by collectively acquiring data in a certain period may be assigned to the STD. The cycle is assigned to the item of the EOD of the format.

Although detailed description is omitted to avoid repetition, the same processing is performed with respect to record information and corresponding video information. As a result, diagnosis intermediate data corresponding to a data element of the probe data is generated.

As described above, the data codes indicating a traveling condition of the automobile, which is a moving body, are assigned to the diagnosis intermediate data generated based on the data elements of the probe data.

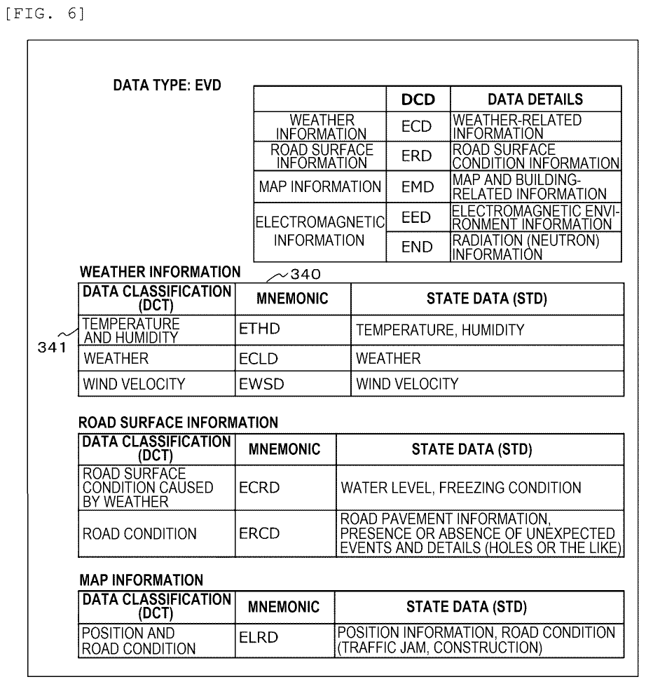

FIG. 6 is a diagram illustrating definitions relating to data details and code conversion of data classification in a case where the data type (TYP) is the EVD (environmental data). The diagnosis intermediate data generation unit 113 encodes contents of extracted data elements according to the definitions and assigns the codes to corresponding items of the data format.

For example, when information included in an extracted data element and indicating data details indicates weather, the diagnosis intermediate data generation unit 113 converts the information into a code called ECD and assigns the code to the item of DCD of the format.

In this case, the diagnosis intermediate data generation unit 113 specifies a record 341 in a weather information table 340 in which a temperature and humidity indicating a weather condition are associated with the state data. Further, the diagnosis intermediate data generation unit 113 converts the temperature and humidity corresponding to data classification of the specified record into a code=ETHD defined by a mnemonic of the record, and assigns the code to the DCT item of the format.

The diagnosis intermediate data generation unit 113 specifies the state data of the temperature and humidity from the extracted data element, and assigns an actual value of the state data to the STD of the format.

Although detailed description is omitted to avoid repetition, the same processing is performed with respect to a road surface freezing state and map position information corresponding to road surface information and map information. As a result, diagnosis intermediate data indicating data elements related to an environment is generated.

As described above, the data codes indicating an environmental condition around the automobile, which is a moving body, are assigned to the diagnosis intermediate data generated based on the data elements of the environmental data.

The diagnosis intermediate data generation unit 113 generates diagnosis intermediate data related to the user data, the user comment data, and the connected service data by the same method as described above.

Specifically, the data element extraction unit 112 extracts a data element from product data included in the user data. By the same method as described above, the diagnosis intermediate data generation unit 113 converts the extracted data element into a predetermined data code indicating a state of a component, and assigns the predetermined data code to a corresponding item of the diagnosis intermediate data. As described above, the data code indicating the state of the component of the moving body is assigned to the diagnosis intermediate data generated based on the data element of the product data.

For example, the data element extraction unit 112 performs interpretation processing such as natural language analysis on the description of a natural language, which is frequently included in failure interview data included in the user data and a user comment and a dealer comment included in the user comment data. By the interpretation processing, the data element extraction unit 112 specifies data details, data classification, and state data, which are corresponding to contents of the interview data, the user comment and the like indicating a state evaluation of the moving body on which the edge system 230 is mounted.

More specifically, the data element extraction unit 112 extracts, as a data element, a natural language representing a state evaluation on a target vehicle, a failure situation and the like from the user data and the user comment data by natural language analysis. The diagnosis intermediate data generation unit 113 specifies a correspondence relationship between the extracted data element and the DCD, the DTC, and the STD based on the rule information stored in the individual analysis rule DB 121. The diagnosis intermediate data generation unit 113 generates the diagnosis intermediate data by converting the extracted data element into a code corresponding to the specified DCD or DTC and assigning the code to a corresponding item of the format. As actual values of the state data, for example, the interview contents and the user comment may be assigned to the STD.

As described above, a data code indicating a state evaluation on the moving body is assigned to the diagnosis intermediate data that is generated based on the data elements of the failure interview data included in the user data, the user comment included in the user comment data, and the like.

When the acquired data is connected data, the data element extraction unit 112 interprets a communication log between an automobile and a smartphone (or an infrastructure facility such as a charging station) included in the data based on syntax analysis, and extracts data elements indicating a failure. By the same method as described above, the diagnosis intermediate data generation unit 113 encodes the extracted data elements, and assigns the codes to the corresponding items of the format to generate the diagnosis intermediate data.

As described above, the diagnosis intermediate data generated based on the data elements of the connected data is assigned a data code indicating a failure of cooperation between the edge system 230 of the moving body, the connected service data output device 240, and various devices used for a connected service.

The sorting and merging unit 114 is a functional unit configured to rearrange pieces of data in time series for each time element (OTM) included in the diagnosis intermediate data. The sorting and merging unit 114 merges these pieces of data to generate a data set that is easily used for analysis of failure diagnosis, machine learning of an information model used for failure diagnosis, and the like.

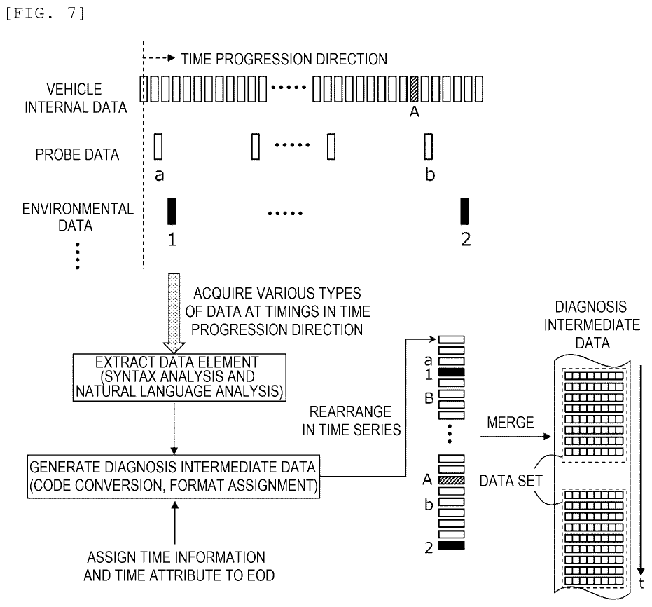

FIG. 7 is a diagram schematically illustrating rearranged (sorted) and merged diagnosis intermediate data. As shown in the drawing, various types of data acquired from an external device, such as the vehicle internal data, the probe data, and the environmental data, are subjected to syntax analysis and natural language analysis based on the processing performed by the data element extraction unit 112 to extract data elements. Further, based on the extracted data elements, diagnosis intermediate data in which time information such as an event occurrence time and a time attribute related to a cycle are assigned to the OTM and the EOD is generated.

The sorting and merging unit 114 performs processing of rearranging the data in time series according to the time information of the diagnosis intermediate data. In the illustrated example, the sorting and merging unit 114 rearranges vehicle internal data A, probe data a and b, and environmental data 1 and 2 in the order of the probe data a, the environmental data 1, the vehicle internal data A, the probe b, and the environmental data 2.

The sorting and merging unit 114 generates one or a plurality of data sets by merging the rearranged diagnosis intermediate data.

The merging and sorting unit may rearrange the diagnosis intermediate data, to which the category of long cycle is assigned, so as to appear a plurality of times in one data set as data of a fixed cycle (for example, a short cycle) shorter than the long cycle. By such rearrangement, in the diagnosis analysis processing using, for example, diagnosis intermediate data of a short cycle (for example, corresponding to vehicle internal data), it is possible to facilitate the processing of associating the diagnosis intermediate data of a short cycle with diagnosis intermediate data of a long cycle (for example, environmental data) indicating an environment of the edge system 230 at each timing.

The diagnosis analysis unit 115 is a functional unit configured to diagnose and analyze a failure in the edge system 230. Specifically, the diagnosis analysis unit 115 executes the diagnosis analysis processing of the failure in the edge system 230 using the data set of the diagnosis intermediate data. More specifically, the diagnosis analysis unit 115 determines processing contents and a processing order of the diagnosis analysis based on the data codes and the actual values assigned to the items (for example, the DCD, the DCT, and the STD described above) of the diagnosis intermediate data, and performs the diagnosis analysis processing of the failure in the edge system 230 according to the processing contents and the processing order.

The diagnosis result output unit 116 is a functional unit configured to output a diagnosis result. Specifically, the diagnosis result output unit 116 outputs the diagnosis result to an output device such as a display or a printer provided in the failure diagnosis device 100.

Next, the storage unit will be described. The storage unit 120 is a functional unit configured to store various types of information used for processing to be executed by the failure diagnosis device 100. The storage unit 120 stores information generated by the failure diagnosis device 100. Specifically, the storage unit 120 includes the individual analysis rule DB 121 and a diagnosis intermediate data storage DB 122.

The individual analysis rule DB 121 is a database that stores rule information used for analyzing various types of data acquired from an external device. Specifically, the individual analysis rule DB 121 stores rule information including an individual data structure and a lexical and term rule for analyzing (syntax analysis or natural language analysis) data of formats varying depending on the data type and the data providing source.

The diagnosis intermediate data storage DB 122 is a functional unit configured to store the generated diagnosis intermediate data. Specifically, the diagnosis intermediate data storage DB 122 stores a plurality of pieces of diagnosis intermediate data generated by the diagnosis intermediate data generation unit 113.

Next, the input unit 130, the output unit 140, and the communication unit 150 will be described. The input unit 130 is a functional unit configured to receive input of various instructions and information from an operator of the failure diagnosis device 100.

The output unit 140 is a functional unit configured to output information generated by the failure diagnosis device 100. For example, the output unit 140 outputs (transmits) a generated diagnosis analysis result to a predetermined device via the communication unit 150.

The communication unit 150 is a functional unit configured to perform information communication with an external device. Specifically, the communication unit 150 acquires the user data, the environmental data, the vehicle internal data, the probe data, the user comment data, the connected service data, and the like from the external device. The communication unit 150 transmits information such as the generated diagnosis analysis result to an external predetermined device based on an instruction from the output unit 140.

An example of the functional configuration of the failure diagnosis device 100 has been described above.

### Description of Operation

Next, failure diagnosis processing to be executed by the failure diagnosis device 100 will be described.

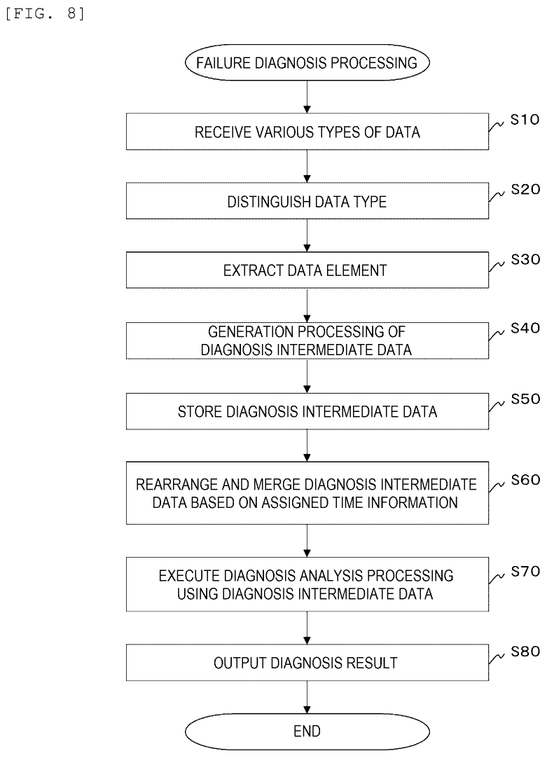

FIG. 8 is a diagram illustrating an example of failure diagnosis processing. The processing is started, for example, when the input unit 130 receives an execution instruction from the operator of the failure diagnosis device 100. The processing may be started when the failure diagnosis device 100 is started, for example.

When the processing is started, the communication unit 150 receives various types of data from an external device (step S10). Specifically, the communication unit 150 receives the user data, the environmental data, the user comment data, the vehicle internal data, the probe data, and the connected service data from the manufacturing company server 200, the environmental data providing server 210, the SNS server 220, the edge system 230, and the connected service data output device 240, respectively.

Next, the data type classification unit 111 distinguishes the type of the acquired data (step S20). Specifically, the data type classification unit 111 distinguishes the type of each piece of data based on an ID assigned to each piece of data. The data type classification unit 111 outputs the distinguished data to the data element extraction unit 112 together with information specifying the type thereof.

Next, the data element extraction unit 112 extracts a data element from each piece of the distinguished data (step S30). Specifically, based on rule information stored in the individual analysis rule DB 121, the data element extraction unit 112 specifies a data structure and a lexical and term rule corresponding to data of formats varying depending on the data type and the data providing source, and performs data interpretation processing according to the rule information.

Accordingly, the data element extraction unit 112 extracts data elements corresponding to the data providing source for each data type from the data acquired from the external device.

Next, the diagnosis intermediate data generation unit 113 generates diagnosis intermediate data (step S40). Specifically, as described above, the diagnosis intermediate data generation unit 113 converts the extracted data element into a predetermined data code corresponding to an item of a common data format regardless of the data type, and generates diagnosis intermediate data in which the code is assigned to the corresponding item.

More specifically, the diagnosis intermediate data generation unit 113 generates the diagnosis intermediate data by converting the data type and the extracted data element into a data code according to a predetermined format rule and assigning the data code to a corresponding item of the format. The diagnosis intermediate data generation unit 113 stores the generated diagnosis intermediate data in the diagnosis intermediate data storage DB 122 (step S50).

Next, the sorting and merging unit 114 rearranges and merges the diagnosis intermediate data (step S60). Specifically, the sorting and merging unit 114 rearranges the order of the pieces of data based on time information assigned to the diagnosis intermediate data, and merges the pieces of data to generate one or a plurality of data sets.

Next, the diagnosis analysis unit 115 performs diagnosis analysis processing using the generated data set of the diagnosis intermediate data (step S70). Specifically, the diagnosis analysis unit 115 performs diagnosis analysis on data elements included in the various types of data by using diagnosis intermediate data having a unified data format.

The diagnosis analysis method is not particularly limited, and it is sufficient to apply a known diagnosis analysis technique as long as the diagnosis is performed using diagnosis intermediate data obtained by encoding data elements based on a predetermined definition.

In the diagnosis analysis, for example, an information model that receives diagnosis intermediate data as input and outputs a diagnosis result may be used. In this case, for example, it is sufficient to use an information model of failure diagnosis generated by subjecting a mathematical model such as a neural network to machine learning.

Next, the diagnosis result output unit 116 outputs a diagnosis result obtained by the diagnosis analysis unit 115 (step S80). Specifically, the diagnosis result output unit 116 outputs information indicating the diagnosis result to an output device such as a display provided in the failure diagnosis device 100.

After outputting the diagnosis result, the diagnosis result output unit 116 ends the flow of processing.

The failure diagnosis system 1000 according to the embodiment has been described above.

According to such a failure diagnosis system, by converting various types of data into data in a more easily usable format, the failure diagnosis can be performed more efficiently using the data.

In particular, the failure diagnosis device can convert data of formats varying depending on the data providing source into a unified data format by replacing the data with a predetermined code, and perform analysis processing of failure diagnosis using the converted data. Therefore, with the failure diagnosis device, the difference in the data providing source can be absorbed and the processing efficiency and the processing speed of the diagnosis processing can be improved.

Since the failure diagnosis device 100 can perform analysis of the failure diagnosis using data of various types and fields whose data formats are unified, it is possible to improve the analysis accuracy.

Further, since the analysis processing of the failure diagnosis is performed using the data having the unified data format, it is possible to facilitate generation of an information model for performing the analysis processing.

### Second Embodiment

In the failure diagnosis system 1000 according to a second embodiment of the invention, an influence degree on occurrence of a failure is calculated for a factor that may indirectly influence the function of a vehicle device, such as a traveling environment like a weather condition or vibration during traveling, and information on the influence degree is included in diagnosis intermediate data, thereby improving the accuracy of diagnosis analysis.

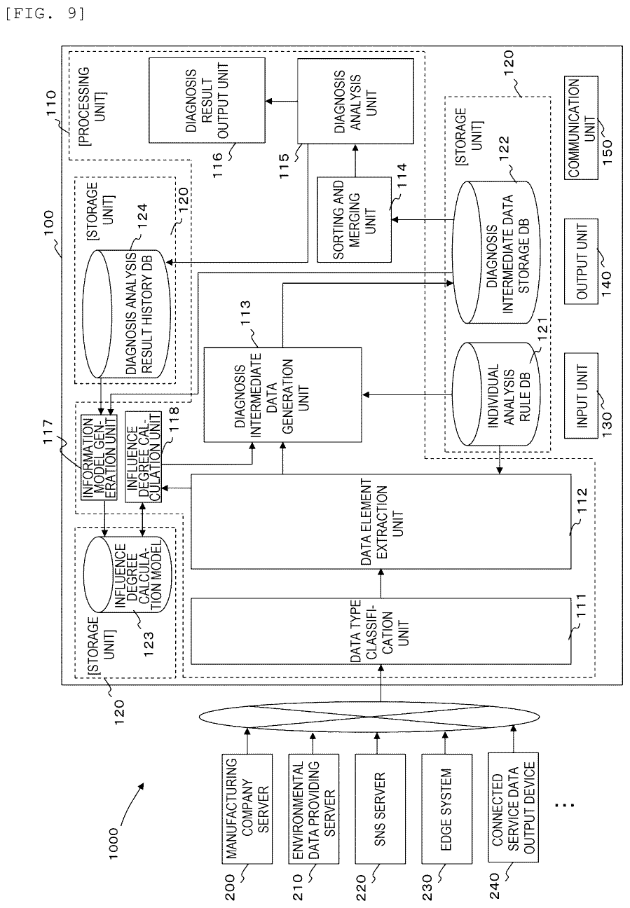

FIG. 9 is a diagram illustrating an example of a schematic configuration of the failure diagnosis system 1000 according to the embodiment. As illustrated, the failure diagnosis device 100 further includes an information model generation unit 117, an influence degree calculation unit 118, an influence degree calculation model 123, and a diagnosis analysis result history DB 124 in addition to the functional units of the failure diagnosis device 100 according to the first embodiment. Since the other configurations of the failure diagnosis system 1000 are the same as those of the first embodiment, the following description will be made focusing on configurations different from those of the first embodiment.

The information model generation unit 117 is a functional unit configured to generate the influence degree calculation model 123 that is an information model for calculating a failure influence degree. Specifically, the information model generation unit 117 generates the influence degree calculation model 123 as an initial model by performing machine learning on a mathematical model such as a neural network using, for example, past diagnosis intermediate data stored in the diagnosis intermediate data storage unit DB 122.

In this way, by using the diagnosis intermediate data in the machine learning, the information model generation unit 117 can perform the machine learning without considering the difference in the data format depending on the data type and the data providing source, and can speed up the generation processing of the information model.

The type of the information model is not limited to the neural network, and may be defined by, for example, a causal relationship graph. The data used for the machine learning is not limited to the diagnosis intermediate data, and may be environmental data, probe data, or the like acquired from an external device.

The information model generation unit 117 acquires a diagnosis analysis result corresponding to the diagnosis intermediate data used in the machine learning from the diagnosis analysis result history DB 124, and updates the influence degree calculation model 123 by performing machine learning using the diagnosis analysis result as feedback data. Specifically, the information model generation unit 117 acquires the diagnosis analysis result corresponding to the diagnosis intermediate data used at the time of generation of the initial model from the diagnosis analysis result history DB 124. Further, the information model generation unit 117 updates the influence degree calculation model 123 by performing, at a predetermined timing (for example, at a timing at which a predetermined number of diagnosis analysis results are accumulated or at regular intervals such as weekly or monthly), the machine learning using the acquired diagnosis analysis result. Examples of the method for updating include covariance structure analysis.

In this way, the information model generation unit 117 updates the influence degree calculation model 123 indicating a causal relationship with a failure by using the diagnosis analysis result as feedback data. It is possible to improve the calculation accuracy of the influence degree by updating the influence degree calculation model 123.

The influence degree calculation model 123 is an information model for calculating an influence degree indicating a degree of causal relationship between a use environment and a traveling condition of the edge system 230 and a failure (breakdown) of a component in a device. Specifically, when a data element extracted from information that is not directly related to a function of a device in the edge system 230, such as environmental data or probe data, is input, the influence degree calculation model 123 outputs the influence degree that the use environment and the traveling condition indicated by the data element has on the component to cause a failure (or breakdown).

The diagnosis analysis result history DB 124 is a database that stores diagnosis analysis results for which diagnosis intermediate data is used. The diagnosis analysis result history DB 124 stores a plurality of results of diagnosis analysis processing in which past diagnosis intermediate data is used.

The influence degree calculation unit 118 is a functional unit configured to calculate the failure influence degree in the edge system 230 using the influence degree calculation model 123. Specifically, when a data element extracted from information that is not directly related to a function of a device in the edge system 230, such as environmental data or probe data is acquired from the data element extraction unit 112, the influence degree calculation unit 118 inputs the data element to the influence degree calculation model 123.

The influence degree calculation unit 118 outputs a value, which is output from the influence degree calculation model 123, to the diagnosis intermediate data generation unit 113. The diagnosis intermediate data generation unit 113 assigns the value (the value indicating the influence degree) acquired from the influence degree calculation unit 118 to the item of IED in the format of the diagnosis intermediate data.

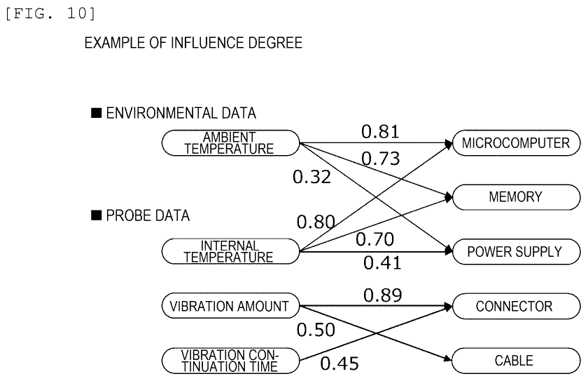

FIG. 10 is a diagram illustrating an example of the influence degree. The illustrated example shows that influence degrees of an ambient temperature, which is a data element extracted from the environmental data, on a microcomputer, a memory, and a power supply, which are components of the edge system 230, are 0.81, 0.73, and 0.32, respectively. Further, for example, it is shown that influence degrees of an internal temperature, which is a data element extracted from the probe data, on the microcomputer, the memory, and the power supply, which are components of the edge system 230, are 0.80, 0.70, and 0.41, respectively.

The failure diagnosis system 1000 according to the second embodiment has been described above.

According to the failure diagnosis system 1000, it is possible to assign the influence degree on occurrence of the failure to the diagnosis intermediate data for the factor that may indirectly influence the function of the vehicle device, such as a traveling environment like a weather condition or vibration during traveling. As a result, the amount of information of the diagnosis intermediate data used in the diagnosis analysis processing can be increased, and the accuracy of diagnosis analysis can be improved.

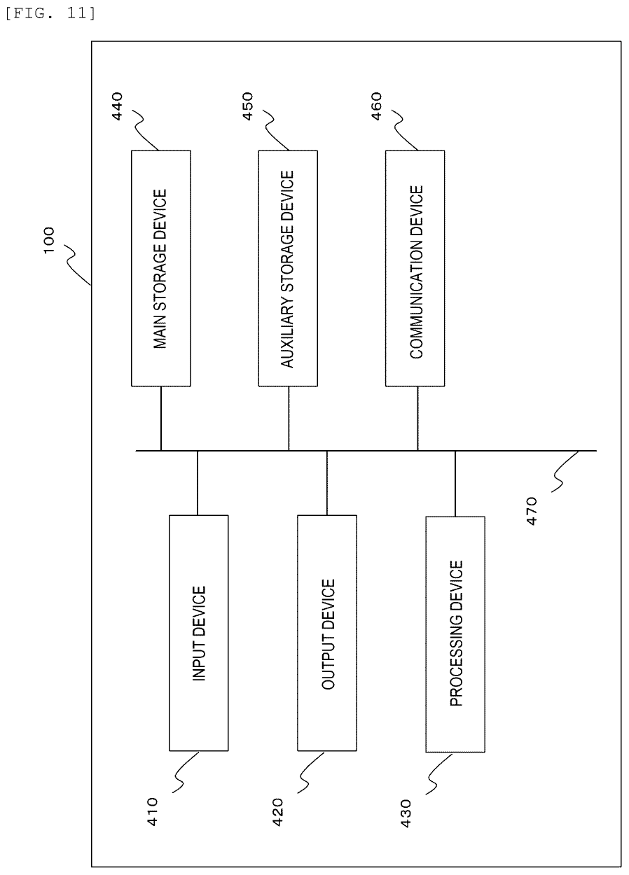

FIG. 11 is a diagram illustrating an example of a hardware structure of the failure diagnosis device 100. The failure diagnosis device 100 is a computer such as a cloud server. As illustrated, the failure diagnosis device 100 includes an input device 410, an output device 420, a processing device 430, a main storage device 440, an auxiliary storage device 450, a communication device 460, and a bus 470 that electrically connects these devices.

The input device 410 is a device for an operator to input information and instructions to the failure diagnosis device 100. Specifically, the input device 410 is a touch panel, a keyboard, a mouse, or a voice input device such as a microphone.

The output device 420 is a device configured to output information generated by the failure diagnosis device 100. Specifically, the output device 420 is a display, a printer, or a speaker.

The processing device 430 is, for example, a device configured to perform arithmetic processing. Specifically, the processing device 430 is a central processing unit (CPU), a microprocessor, a graphics processing unit (GPU), a field programmable gate array (FPGA), or another semiconductor device that can perform arithmetic processing.

The main storage device 440 is a memory device such as a random access memory (RAM) that temporarily stores various types of read information or a read only memory (ROM) that stores programs and application programs to be executed by the processing device 430 and other various types of information. The auxiliary storage device 450 is a nonvolatile storage device such as a hard disk drive (HDD), a solid state drive (SSD), or a flash memory capable of storing digital information.

The communication device 460 is a device configured to perform wireless or wired information communication with an external device.

The hardware structure of the failure diagnosis device 100 has been described above.

The processing unit 110 of the failure diagnosis device 100 is implemented by a program that causes the processing device 430 (for example, a CPU) to perform processing. The programs are stored in, for example, the main storage device 440 or the auxiliary storage device 450, and are loaded into the main storage device 440 to be executed and are executed by the processing device 430. The storage unit 120 may be implemented by the main storage device 440 or the auxiliary storage device 450, or may be implemented by a combination thereof. The communication unit 150 is implemented by the communication device 460.

Each functional block of the failure diagnosis device 100 is classified according to main processing contents in order to facilitate understanding of each function implemented in the embodiment. Accordingly, the invention is not limited by the way of classification of each function and a name thereof. Each configuration of the failure diagnosis device 100 may be classified into more components according to processing contents. Further, one component may be classified so as to execute more processing.

All or some of the functional units may be configured with hardware (integrated circuit such as ASIC) mounted on a computer. The processing of each functional unit may be executed by one piece of hardware or may be executed by a plurality of pieces of hardware.

The invention is not limited to the above-described embodiments and modifications, and includes various other embodiments and modifications. For example, the embodiments described above are described in detail to facilitate understanding of the invention, and the invention is not necessarily limited to those including all the configurations described above. A part of a configuration of a certain embodiment can be replaced with a configuration of another embodiment or modification, and a configuration of another embodiment can be added to a configuration of a certain embodiment. In addition, another configuration can be added to, deleted from, or replaced with a part of a configuration of each embodiment.

In the above description, control lines and information lines considered to be necessary for description are shown in the drawings, and not all control lines and information lines in a product are necessarily shown. Actually, almost all configurations may be considered to be connected to one another.

### REFERENCE SIGNS LIST

1000: FAILURE DIAGNOSIS SYSTEM
100: FAILURE DIAGNOSIS DEVICE
110: PROCESSING UNIT
111: DATA TYPE CLASSIFICATION UNIT
112: DATA ELEMENT EXTRACTION UNIT
48/57
113: DIAGNOSIS INTERMEDIATE DATA GENERATION UNIT
114: SORTING AND MERGING UNIT
115: DIAGNOSIS ANALYSIS UNIT
116: DIAGNOSIS RESULT OUTPUT UNIT
117: INFORMATION MODEL GENERATION UNIT
118: INFLUENCE DEGREE CALCULATION UNIT
120: STORAGE UNIT
121: INDIVIDUAL ANALYSIS RULE DB
122: DIAGNOSIS INTERMEDIATE DATA STORAGE DB
123: INFLUENCE DEGREE CALCULATION MODEL
124: DIAGNOSIS ANALYSIS RESULT HISTORY DB
130: INPUT UNIT
140: OUTPUT UNIT
150: COMMUNICATION UNIT
200: MANUFACTURING COMPANY SERVER
210: ENVIRONMENTAL DATA PROVIDING SERVER
220: SNS SERVER
230: EDGE SYSTEM
240: CONNECTED SERVICE DATA OUTPUT DEVICE
410: INPUT DEVICE
420: OUTPUT DEVICE
430: PROCESSING DEVICE
440: MAIN STORAGE DEVICE
450: AUXILIARY STORAGE DEVICE
460: COMMUNICATION DEVICE
470: BUS
49/57
N: NETWORK

1. A failure diagnosis system comprising:
an edge system which is an electronic system;
a failure diagnosis device configured to diagnose a failure of the edge system; and
a computer which is an external device, wherein
the failure diagnosis device
distinguishes data acquired from the edge system and the computer according to a type of the data,
extracts a data element included in the data based on predetermined interpretation processing for the data,
converts the data element into a predetermined data code corresponding to an item of a common data format regardless of the type of the data, and generates diagnosis intermediate data in which the data code is assigned to the corresponding item, and
performs diagnosis analysis of a failure in the edge system using the diagnosis intermediate data.

2. The failure diagnosis system according to claim 1, wherein
the data format of the diagnosis intermediate data includes
an item to which a data code indicating the type of the data is assigned,
an item to which a data code indicating details of the data is assigned,
an item to which an acquisition time of the data or an event occurrence time of a failure in the edge system is assigned,
an item to which a classification code of the data is assigned, and
an item to which an actual value of the data indicating a state is assigned.

3. The failure diagnosis system according to claim 2, wherein
the failure diagnosis device generates a data set, in which the diagnosis intermediate data is rearranged in time series, based on the acquisition time of the data or the event occurrence time.

4. The failure diagnosis system according to claim 2, wherein
the edge system is a system that is mounted on a moving body and electronically controls driving of the moving body.

5. The failure diagnosis system according to claim 4, wherein
the data code, which is converted based on the data element extracted from internal data of the moving body and indicates a state of the moving body, is assigned to the diagnosis intermediate data.

6. The failure diagnosis system according to claim 4, wherein
the data code, which is converted based on the data element extracted from probe data of the moving body and indicates a traveling condition of the moving body, is assigned to the diagnosis intermediate data.

7. The failure diagnosis system according to claim 4, wherein
the data code, which is converted based on the data element extracted from environmental data including a weather condition and a road surface condition and indicates an environmental condition around the moving body, is assigned to the diagnosis intermediate data.

8. The failure diagnosis system according to claim 4, wherein
the data code, which is converted based on the data element extracted from product data of the moving body and indicates a state of a component of the moving body, is assigned to the diagnosis intermediate data.

9. The failure diagnosis system according to claim 4, wherein
the data code, which is converted based on the data element extracted from user data and indicates a state evaluation on the moving body, is assigned to the diagnosis intermediate data.

10. The failure diagnosis system according to claim 4, wherein
the data code, which is converted based on the data element extracted from data regarding a cooperation service with the edge system and indicates a failure in the cooperation service, is assigned to the diagnosis intermediate data.

11. The failure diagnosis system according to claim 2, wherein
the failure diagnosis device determines processing contents and a processing order of the diagnosis analysis based on the data code assigned to the item.

12. The failure diagnosis system according to claim 1, wherein
the failure diagnosis device
inputs the data element to an influence degree calculation model generated by machine learning using the diagnosis intermediate data to calculate an influence degree that a use environment of the edge system has on the edge system to cause a failure, and
assigns the calculated influence degree to a corresponding item of the diagnosis intermediate data.

13. The failure diagnosis system according to claim 12, wherein
the failure diagnosis device updates the influence degree calculation model based on a processing result of the diagnosis analysis in which the diagnosis intermediate data is used.

14. A failure diagnosis device for diagnosing a failure of an edge system which is an electronic system, the failure diagnosis device comprising:
a data type classification unit configured to distinguish data acquired from the edge system and an external device according to a type of the data;
a data element extraction unit configured to extract a data element included in the data based on predetermined interpretation processing for the data;
a diagnosis intermediate data generation unit configured to convert the data element into a predetermined data code corresponding to an item of a common data format regardless of the type of the data and generate diagnosis intermediate data in which the data code is assigned to the corresponding item; and
a diagnosis analysis unit configured to perform diagnosis analysis of a failure in the edge system using the diagnosis intermediate data.

15. A failure diagnosis method to be executed by a failure diagnosis device for diagnosing a failure of an edge system which is an electronic system, the failure diagnosis method comprising:
the failure diagnosis device performing
a data type classification step of distinguishing data acquired from the edge system and an external device according to a type of the data;
a data element extraction step of extracting a data element included in the data based on predetermined interpretation processing for the data;
a diagnosis intermediate data generation step of converting the data element into a predetermined data code corresponding to an item of a common data format regardless of the type of the data and generating diagnosis intermediate data in which the data code is assigned to the corresponding item; and
a diagnosis analysis step of performing diagnosis analysis of a failure in the edge system using the diagnosis intermediate data.
